(19) United States
(12) Patent Application Publication
(10) Pub. No.: US 2008/0135550 A1
(43) Pub. Date: Jun. 12, 2008

(54) COLLAPSIBLE PORTABLE CONTAINER

(76) Inventor: Linda K. Williams, Gulver City, CA (US)

Correspondence Address: LINDON & LINDON, 1250 LINDA STREET, ROCKY RIVER, OH, 44116, US

(21) Appl. No.: 11/567,312

(22) Filed: Dec. 6, 2006

(51) Int. Cl. A45C 7/00; B62B 1/04

(52) U.S. Cl. 220/9.2; 280/652

(57) ABSTRACT

A collapsible container having a generally spiral longitudinal frame and a top frame operatively connected to the longitudinal frame. The container also includes a bottom frame operatively connected to the longitudinal frame. The bottom frame is generally rounded and positioned generally parallel to the top frame.

### BACKGROUND OF THE INVENTION

Baskets can be useful for a variety of applications. They can hold a number of objects for further batch processing. For example, a basket can hold a load of laundry for washing, a load of sporting equipment for storage and future access, a load of parts for an assembly processing and the like.

Baskets can be bulky and clumsy. A basket that requires too much space can be undesirable. A basket that is not sufficiently mobile can likewise be undesirable. Current attempts to make baskets more compactable and mobile have been largely unsuccessful. There remains a long-felt need for a suitable means of creating a basket which is more compactable and mobile.

### BRIEF DESCRIPTION OF THE DRAWINGS

FIG. 1 is a top perspective view in elevation of a basket in accordance with the present invention.

FIG. 2 is a view in elevation of the basket (extended) of FIG. 1 also showing a mesh covering.

FIG. 3 is a bottom perspective view in elevation of the basket of FIG. 1.

FIG. 4 is a top perspective view in elevation of the base of the basket of FIG. 1.

FIG. 5 is a bottom perspective view in elevation of the base of the basket of FIG. 1.

FIG. 6 is a top plan view of the base of the basket of FIG. 1.

FIG. 7 is a bottom plan view of the base of the basket of FIG. 1.

FIG. 8 is a view in elevation of the basket (collapsed) of FIG. 1.

### SUMMARY OF INVENTION

There is provided a collapsible container having a generally spiral longitudinal frame and a top frame operatively connected to the longitudinal frame. The container also includes a bottom frame operatively connected to the longitudinal frame. The bottom frame is generally rounded and positioned generally parallel to the top frame. There is also provided a collapsible container having a generally spiral longitudinal frame provided along a generally vertical first axis and a top frame operatively connected to the longitudinal frame.

### DETAILED DESCRIPTION OF THE INVENTION

Preliminarily, it should be noted that certain terms used herein, such as for example above, below, upper, lower, left and right, are used to facilitate the description of the invention. Unless otherwise specified or made apparent by the context of the discussion, such terms and other directional terms should be interpreted with reference to the figure(s) under discussion. Such terms are not intended as a limitation on the position in which the invention or components may be used. Indeed, it is contemplated that the components of the invention may be easily positioned in any desired orientation for use. Likewise, numerical terms such as for example “first”, and “second” are not intended as a limitation or to imply a sequence, unless otherwise specified or made apparent by the context of the discussion. The term “operatively connected” is understood to include a linking together of the portions under consideration and may include a physical engagement and/or a functional or operational connection.

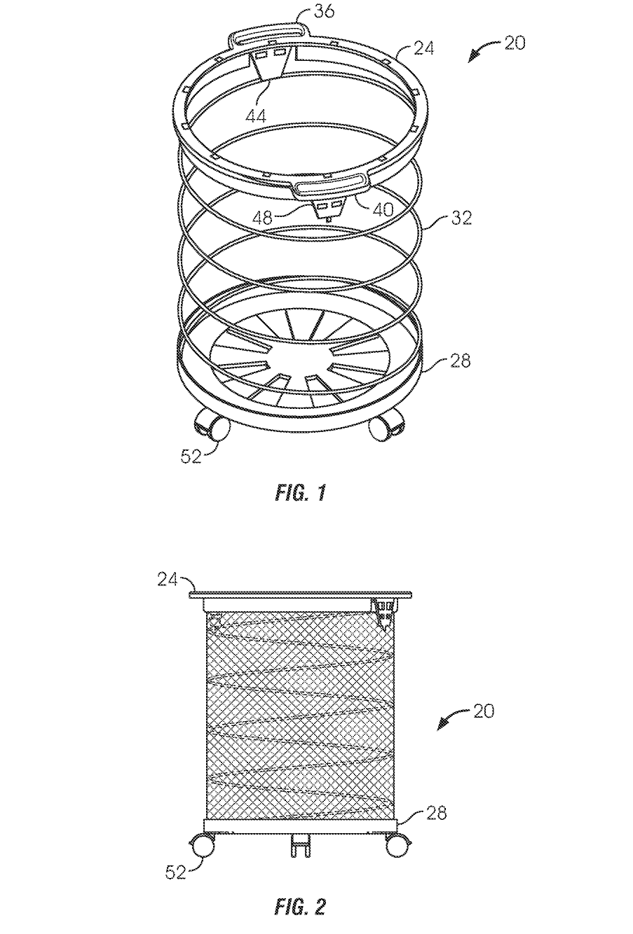

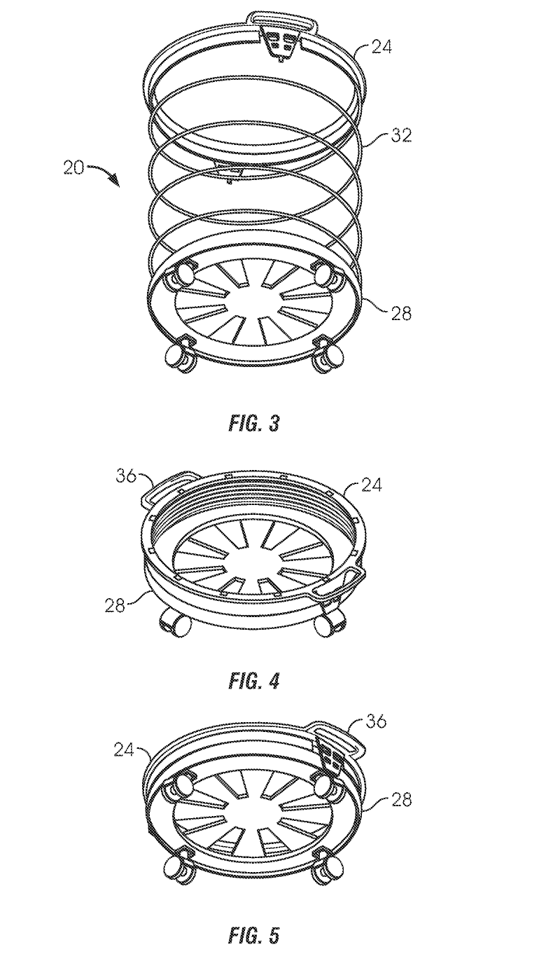

Referring now to the drawings, there is illustrated in FIGS. 1 through 8 a collapsible portable container indicated generally at 20, according to the invention. The collapsible portable container 20 is a basket and will generally be referred to as such for ease of reference. The term “basket” as used in this application may be understood to include, but is not limited to, any structure or functionality which generally contains, holds or carries things. The illustrated basket 20 includes a top frame 24 and a bottom frame 28 operatively connected to a generally spiral longitudinal frame 32.

The term “frame” as used in this application may be understood to include, but is not limited to, any structure or functionality which supports another structure or other object. The frames described herein may also be considered supports, which may be components to generally hold up, serve as a foundation for, and/or prop up something. The term “spiral” as used in this application may be understood to include, but is not limited to, any structure or functionality which includes curves that generally circle around a central point or axis. The term “axis” as used in this application may be understood to include, but is not limited to, a generally straight line about which a body or a geometric figure rotates or may be supposed to rotate. The “axis” may be a generally straight line with respect to which a body, component, or figure may be generally symmetrical. The “axis” may be a reference line of a coordinate system. One nonlimiting example of a spiral is a helix.

The illustrated top frame 24 is generally rounded and may be any suitable shape or configuration. The illustrated top frame 24 includes two handles 36, 40 and two clasps 44, 48. The handles 36, 40 illustrated and clasps 44, 48 illustrated are on opposing sides of the top frame 24, and may be positioned in any suitable numbers and positions as desired. The illustrated top frame 24 includes a plurality of notches in an upper surface thereof. The clasps 44, 48 may function as a coupling and may be replaced or augmented by any suitable coupling structure. The term “coupling” may include [but is not limited to] one or more structures or components that join two things, including a device for connecting two things and/or objects.

When the basket 20 is in a collapsed position, such as is shown in FIG. 4, the clasps 44, 48 selectively engage the bottom frame 28 of the basket 20. To generally open the basket 20 from a collapsed position, the user (not shown) may push generally downwardly on the top frame 24 of the basket 20, thereby selectively disengaging the clasps 44, 48 from the bottom frame 28 of the basket 20. When the generally spiral longitudinal frame 32 is in a generally collapsed position, energy is stored therein, allowing the bottom frame 28 and top frame 24 to generally separate when the clasps 44, 48 disengage. Selectively pulling generally radially on the clasps 44, 48 can assist disengagement of the clasps 44, 48.

When the generally spiral longitudinal frame 32 is in a generally collapsed position, the clasps 44, 48 are proximate the bottom frame 28 of the basket 20. The term “proximate” as used in this application may be understood to include, but is not limited to, a general nearness or closeness in space, time, and/or relationship. When the generally spiral longitudinal frame 32 is in a generally collapsed position, the clasps 44, 48 are adjacent to the bottom frame 28 of the basket 20. The term “adjacent” may include [but is not limited to] structures or components situated generally near or generally close to each other, which may or may not be touching and/or connected.

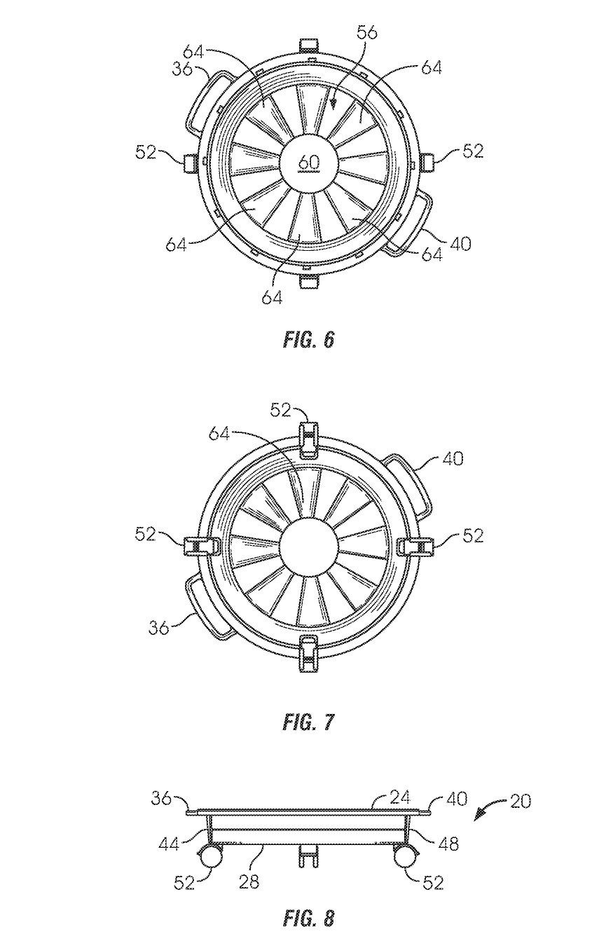

The illustrated bottom frame 28 is generally rounded and may be any suitable shape or configuration. The bottom frame 28 may be operatively connected to a plurality of wheels 52. Any suitable numbers and positioning of wheels 52 may be employed. Two wheels are shown in FIG. 1 and two wheels are out of perspective view. Four wheels are shown in FIGS. 6 and 7. The wheels may be employed to enhance mobility of the basket 20. The bottom frame 28 shown includes a generally lattice central portion 56. The illustrated central portion 56 includes a hub 60 and a plurality of spoke structures 64 extending from the hub 60.

The illustrated spiral longitudinal frame 32 generally extends between the top frame 24 and the bottom frame 28. The spiral frame 32 preferably consists of a generally rigid or generally stiff material. The spiral longitudinal frame 32 may ascend and/or descend at any suitable angle. The term “angle” as used in this application may be understood to include, but is not limited to, any structure or functionality which defines or creates a corner. The corner may constitute a projecting part or an enclosed or partially enclosed space. The corner may be generally straight, generally curved or arced—or partially straight or curved. The term “angle” may also include the space between two lines or surfaces at or near the point at which they touch or intersect.

In operation, the basket 20 is selectively positionable in a wide variety of generally open, expanded positions as well as generally closed, collapsed positions. The basket 20 may be biased towards a generally open position and ready to accept a load, such as for example a load of clothing or other suitable load. In the generally closed, collapsed positions the clasps 44, 48 may be operatively connected to the bottom frame 28 of the basket 20. Because wheels may be provided as shown on the bottom frame 28 or as desired, the basket 20 is desirable for use by those with limited ability to push an awkward object—such as those with back pain, leg injury or other physical ailment.

The invention may be made from any suitable material and by any suitable method. The invention may be adapted to fit a wide variety of uses. It will be appreciated that the components of the invention may be easily modified as needed to accommodate varying sizes and shapes.

It is to be understood that the invention is not limited in its application to the details of construction and to the arrangements of the components set forth in the accompanying description or illustrated in the drawings. The invention is capable of other embodiments and of being practiced and carried out in various ways. Also, it is to be understood that the phraseology and terminology employed herein are for the purpose of description and should not be regarded as limiting. The disclosure may readily be utilized as a basis for the designing of other structures, methods and systems for carrying out the present invention. It is important, therefore, that the claims be regarded as including equivalent constructions. Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract and disclosure are neither intended to define the invention of the application, which is measured by the claims, nor are they intended to be limiting as to the scope of the invention in any way.

What is claimed is:

1. A collapsible container comprising:
a generally spiral longitudinal frame;
a top frame operatively connected to the longitudinal frame; and
a bottom frame operatively connected to the longitudinal frame,
wherein the bottom frame is generally rounded and positioned generally parallel to the top frame.

2. The collapsible container of claim 1 further comprising a mesh covering operatively connected to the longitudinal frame.

3. The collapsible container of claim 2 wherein the bottom frame includes a generally lattice central portion.

4. The collapsible container of claim 1 wherein the top frame is generally rounded.

5. The collapsible container of claim 4 wherein the bottom frame includes a generally lattice central portion.

6. The collapsible container of claim 1 further comprising a wheel operative to move the container.

7. The collapsible container of claim 1 further comprising a clasp operatively connected to the top frame.

8. The collapsible container of claim 7 wherein the clasp is securable to the bottom frame when the container is in a generally closed position.

9. The collapsible container of claim 7 wherein the bottom frame includes a hub and a plurality of spokes extending from the hub to a periphery of the bottom frame.

10. The collapsible container of claim 7 further comprising a pair of clasps positioned on opposing sides of the top frame.

11. A collapsible container comprising:
a generally spiral longitudinal frame provided along a generally vertical first axis;
a top frame operatively connected to the longitudinal frame and generally perpendicular to the first axis; and
a bottom frame operatively connected to the longitudinal frame and generally perpendicular to the first axis,
wherein the bottom frame is generally rounded and positioned generally parallel to the top frame.

12. The collapsible container of claim 11 further comprising a mesh covering operatively connected to the longitudinal frame.

13. The collapsible container of claim 12 wherein the bottom frame includes a generally lattice central portion.

14. The collapsible container of claim 11 wherein the top frame is generally rounded.

15. The collapsible container of claim 14 wherein the bottom frame includes a generally lattice central portion.

16. The collapsible container of claim 11 further comprising a wheel operative to move the container.

17. The collapsible container of claim 11 further comprising a clasp operatively connected to the top frame.

18. The collapsible container of claim 17 wherein the clasp is securable to the bottom frame when the container is in a generally closed position.

19. The collapsible container of claim 17 wherein the bottom frame includes a hub and a plurality of spokes extending from the hub to a periphery of the bottom frame.

20. The collapsible container of claim 17 further comprising a pair of clasps positioned on opposing sides of the top frame.
